(19) United States
(12) Patent Application Publication
(10) Pub. No.: US 2001/0022781 A1
(43) Pub. Date: Sep. 20, 2001

(54) Wireless communications system with broadcasting transmitter

(76) Inventor: Risto Makipaa, Otava (FI)

Correspondence Address: MCDONNELL BOEHNEN HULBERT & BERGHOFF, 300 SOUTH WACKER DRIVE, SUITE 3200, CHICAGO, IL, 60606, US

(21) Appl. No.: 09/804,862

(22) Filed: Mar. 13, 2001

Related U.S. Application Data
(63) Continuation of application No. PCT/FI99/00753, filed on Sep. 14, 1999.

(30) Foreign Application Priority Data
Sep. 15, 1998 (FI) 981985
Jan. 15, 1999 (FI) 990070

(51) Int. Cl. H04B 7/185

(52) U.S. Cl. 370/316; 370/329

(57) ABSTRACT

A wireless digital telecommunications system which comprises a terminal and a main transmitter which transfers broadcast services to the terminal in a multiplexed frame format at one frequency, the system also comprising an auxiliary transmitter which is synchronized with the main transmitter and sends broadcast services to the terminal in a predetermined time slot of the main transmitter's multiplex frame. The time slot intended for the auxiliary transmitter is determined in the control and identification data field of the main transmitter's multiplex frame.

The system also comprises at least one server which transmits terminal-specific subscriber services and from which there is a data transmission connection to the auxiliary transmitter, which is arranged to send terminal-specific subscriber services to terminals. The terminals are able to establish a data transmission connection to the server transmitting terminal-specific subscriber services, the data transmission connection being used for supplying orders of subscriber services to the server.

The invention relates to a wireless, digital telecommunications system which comprises a main transmitter and a terminal, the main transmitter being arranged to transfer broadcast services to the terminal in a multiplexed frame format at one frequency. The invention also relates to a transmitter and terminal used in the system.

In this specification the term ‘broadcast transmission’ refers to broadcast-type transmission, such as radio and television broadcasts, to terminals within a certain geographic area. In addition to public broadcasting companies, these broadcast transmissions can also be sent by private companies, both the private and the public companies being able to supply services only to a limited number of terminals.

Digital processing and recording methods of audio and video signals have developed so fast during the past years that the conventional analogous transmission technology can no longer meet the quality requirements of digital technology. For this reason new digital broadcast networks will be introduced in the next few years for transmitting radio and television broadcasts. These networks include a digital audio broadcasting network DAB, for which abbreviation T-DAB (Terrestrial DAB) is also used, and a digital video broadcasting network DVB, for which abbreviation DVB-T (DVB Terrestrial) is sometimes used. In fact, the main aim in developing these networks has been to improve the audio and video quality of radio and television broadcasts.

The networks in question are implemented as single-frequency networks, and the services offered in them are transmitted simultaneously at the same frequency. Both networks use OFDM modulation (Orthogonal Frequency Division Multiplexing) which enables use of one frequency without the signals sent by different transmitters interfering with each other. An advantage of the single-frequency network is that it utilizes the frequency band efficiently. In the DAB network, for example, frequency blocks of 1.536 MHz are used for transmission, in which e.g. six high-quality stereo channels or a triple number of speech channels can be transmitted. Inside the frequency block, channels are inserted into an output in a multiplexed form. The single-frequency network requires a sufficient co-channel reduction factor, i.e. a factor defining a sufficient distance between two transmitters sending different programmes at the same frequency. On the other hand, the network needs to be sufficiently dense so that the transmission power can be kept low and delayed signals arriving from far away do not interfere with the audibility of the network. The transmission power needed is only a fraction of the power required by a conventional analogous radio broadcast because the required signal-to-noise ratio is considerably lower.

The intention is to provide multinational, national, subnational, areal and local services in the DAB network. Designing of the DAB network is based on the idea that in national and more limited networks transmitters function at the same frequency and the services to be transferred to terminals in such networks can be implemented by one main transmitter, which can be supported by rebroadcasting stations of lower power, if necessary. Thus local services, for example, are transmitted in the multiplex of an areal output so that the requirement of one frequency can be met in the whole area covered by the areal transmitter. However, the frequency block of the areal output is utilized very inefficiently because a local service is transmitted to the whole area covered by the areal transmitter. The larger the coverage area of the areal transmitter, the fewer local outputs can be inserted into the frequency band available. If the number of local services is to be increased, the coverage areas of areal transmitters must be cut, which in turn increases the costs and is disadvantageous to other services intended for areal transmission. Areal transmitters of the DAB network are also very complicated because in the DAB network local services are usually offered on the basis of a predetermined geographic area. In that case, however, a code needs to be defined for the local output directed to each geographic area so that the terminal can configure with a local service.

A further problem related to the arrangement described above is that, regardless of the increase in the data transmission capacity offered by the DAB network, the capacity cannot be utilized for transmitting terminal-specific services. Terminals in the DAB network typically comprise only a receiver, which means that service orders cannot be transmitted from the terminal. Furthermore, the DAB network is designed for relaying broadcast-type transmissions, and thus the ability of the system to direct transmissions to certain terminals is limited.

An object of the present invention is to provide a telecommunications system to eliminate the above-mentioned drawbacks.

The system of the invention is characterized in that the system also comprises an auxiliary transmitter whose coverage area is substantially smaller than the coverage area of the main transmitter and which is synchronized with the main transmitter and arranged to send broadcast services to the terminal in a predetermined time slot of the main transmitter's multiplex frame.

The transmitter of the invention is characterized in that said transmitter is arranged to synchronize with the main transmitter whose coverage is substantially larger than the coverage area of said transmitter, and said transmitter is arranged to send broadcast services in a predetermined time slot of the main transmitter's multiplex frame.

The terminal of the invention is characterized in that the terminal is arranged to configure with a local service sent by another transmitter on the basis of the information included in the control and identification data field of said frame.

The basic idea of the invention is that technically simplified local transmitters which have a lower power and transmit local services intended for the coverage area of each local transmitter are placed in the coverage area of the areal transmitter. A further idea of the invention is that control and identification data of the services transmitted in a multiplexed form in the areal output are used for reserving a certain time slot from the areal output, during which local transmitters sends their own outputs. The idea of a preferred embodiment of the invention is that a connection is established from the terminal to a server from which terminal-specific services to be sent by the local transmitter can be ordered. The idea of another preferred embodiment of the invention is that the control and identification data of the services transmitted in a multiplexed form in the areal output are used for reserving data transmission capacity from the local output for transmitting terminal-specific subscriber services.

The invention provides significant advantages. The frequency block used by the areal transmitter can be utilized considerably more efficiently since the areal output does not include each local output, but each local transmitter uses certain time slots for sending its own services. Another advantage of the invention is that management of areal transmitters will be considerably simpler. A further advantage is that local transmitters will be simple and inexpensive to implement technically because they are responsible for transmission to their own coverage areas only. In addition, an advantage of a preferred embodiment of the invention is that the network solution designed mainly for broadcast services can also be used for transmitting terminal-specific subscriber services to individual terminals.

The invention will be described in greater detail with reference to the accompanying drawings, in which

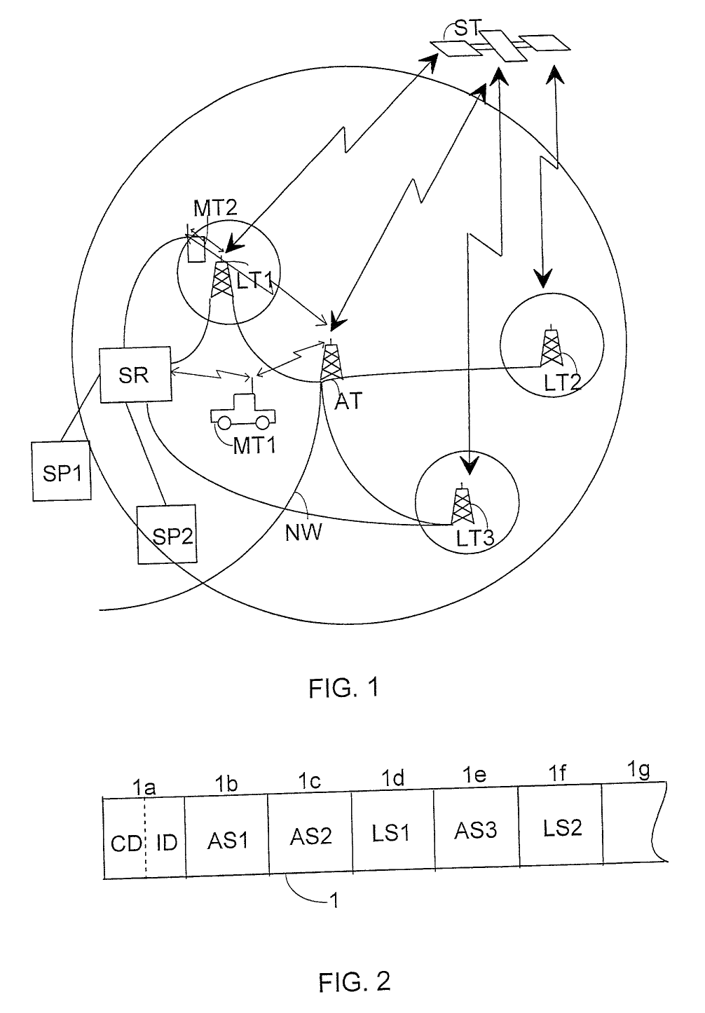

FIG. 1 illustrates, by way of example, the coverage area of an areal transmitter which is provided with local transmitters according to a preferred embodiment of the invention;

FIG. 2 illustrates, by way of example, a typical multiplexed frame of an areal output, and

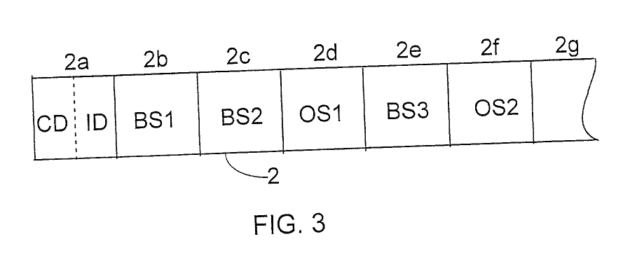

FIG. 3 illustrates, by way of example, a typical multiplexed frame of a local output.

FIG. 1 illustrates the coverage area of an areal transmitter AT, which comprises three local transmitters LT1, LT2 and LT3 as well as their coverage areas according to a preferred embodiment of the invention. The number of local transmitters within the coverage area of one areal transmitter may naturally vary from zero to dozens of local transmitters, for example. The number of local transmitters depends on the size of the coverage area of the areal transmitter and the number of local services needed, which in turn depends primarily on the number and regional distribution of population. The areal transmitter AT transmits an areal output to its whole coverage area, and the services offered in the areal output are multiplexed into the time slots of the frame of the areal output. Mobile terminals MT1 and MT2 are able to receive services provided by the areal transmitter AT within the whole coverage area of the areal transmitter AT and services provided by each local transmitter LT1 to LT3 within the coverage area of each local transmitter LT1 to LT3. The wired network NW and satellite ST of the satellite location system illustrated in FIG. 1 can also be used for synchronization in a manner to be described below. The server SR and its connections to service providers SP1 and SP2 can also be utilized for transmitting terminal-specific subscriber services in a manner to be described below.

FIG. 2 schematically illustrates a typical multiplexed frame 1 of the areal output in which each of the services of different kinds is inserted into a time slot of its own. At the beginning of the frame 1 there are fields (1a) reserved for displaying the control and identification data (CD, ID) included in the frame 1. These control and identification data are used e.g. for determining what services the frame includes, for which area a service is intended and into which time slot each service is inserted. The control and identification data also contain information on the transmission code used in each local area. On the basis of this code the terminal can configure with a local service. In DAB standard ETS 300 401, for example, a field of either 16 or 32 bits is reserved for displaying identification data of the service and a field of 11 bits for determining the geographic target area of the service. The other time slots (1b, 1c, . . . ) of the frame 1 are provided with areal services (AS1, AS2, . . . ) and local services (LS1, LS2, . . . ).

According to a preferred embodiment of the invention, local transmitters send local services in their coverage areas in predetermined time slots during which the areal transmitter comprising the coverage areas of the local transmitters in question does not transmit any services. One or more time slots can be selected from the frame 1 described above. According to the prior art these time slots would be used for transmitting local services (LS1, LS2, . . . ) in the multiplex of an areal output, but according to the present invention local transmitters simultaneously send local services in the slots. In that case the frequency block used by the areal transmitter can be utilized considerably more efficiently because it is not necessary to include each local output in the areal output, but all local transmitters use the same time slots for transmitting their own services. A further advantage of the invention is that the management and structure of areal transmitters will be considerably simpler because they do not need to code small geographic areas into local outputs separately. Technical implementation of local transmitters will also be simple because local transmitters are responsible for transmission in their own coverage areas only. The local output can be coded somewhere else in advance, if necessary, and thus the data to be supplied to the modulator of the local transmitter is source and channel coded data. In that case service data can be transmitted to the local transmitter's memory in a modified form via a wired data network, for example, which enables as simple and inexpensive technical implementation of the local transmitter as possible.

According to a preferred embodiment of the invention, the control and identification data included in the frame of the areal output are used for reserving one or more time slots for local transmitters which send local services within their coverage areas during these time slots. According to the frame structure described above, the control and identification data fields at the beginning of the frame include information on the time slots which are reserved for transmitting local services. The local transmitter is also arranged to receive an areal output from which the local transmitter receives information on the time slots it can use for its own transmission. The control and identification data fields also include information on the code which is to be used in each local area and which the local transmitter uses for coding its transmission. This code can be preferably stored in the memory of the local transmitter or supplied to the local transmitter in the areal output when the code is to be reset, for example. The local transmitter forwards this code in the local output, and consequently the terminals can configure with local services on the basis of the received code.

As regards implementation of the invention, synchronization of areal and local transmitters is highly important, particularly because the network in question is a single-frequency network and terminals are synchronized with the multiplex of the areal output. The DAB and DVB networks given as examples use OFDM modulation, and thanks to the long guard period used in the signals terminals are rather immune e.g. to interference caused by multipath propagation. The signal delay of the local transmitters may not, however, significantly exceed the length of said guard period. According to a preferred embodiment of the invention, synchronization can be implemented by connecting local transmitters to an external reference, such as the wired or wireless network NW of FIG. 1 which feeds a synchronizing signal, or a clock locked to a satellite location system and kept synchronized by means of the signal obtained from the satellite ST. The local transmitter can also be synchronized with the signal of the local output as the local transmitter searches for time slots reserved for local outputs in the control and identification data of the local output.

In the design of networks it is necessary to remember that the retransmission distance should be sufficient for local transmitters. In that case low-power local transmitters located at a sufficient distance from one another can preferably use the same frequency block. In the control and identification data of the areal output the terminals receive information on the time slots multiplexed for local outputs, services to be transmitted in these time slots, size of the services and place of the time slots in the multiplexed frame. On the basis of this information the terminal can configure with the local output. If local transmitters need to be placed close to one another, different frequency blocks must be allocated to them according to a preferred embodiment of the invention. Because the terminals are synchronized with the areal output, the terminal has to reconfigure to receive a local output using the other frequency block. According to a preferred embodiment of the invention, reconfiguration can be performed by means of the satellite location system. A receiver of a satellite location system, such as GPS (Global Positioning System), is integrated into the terminal, which can determine its location by means of this receiver. In response to the location data the terminal determines the local output code used in the area in question. An algorithm typical of the system in question can be used for determining the code, such as the code determination method described in DAB standard ETS 300 401 (June 1996, pp. 118 to 121).

According to a preferred embodiment of the invention, terminal-specific subscriber services can also be transmitted in a multiplex frame reserved for local transmitters. For this to be possible the terminal must be provided with a feedback connection to the local transmitter, which, according to a preferred embodiment of the invention, is implemented via a server supplying subscriber services. According to FIG. 1, the terminal may communicate with the server either wirelessly, like mobile terminal MT1 in FIG. 1, or a via a wired network, like terminal MT2. The wired connection can be implemented by means of any wired network able to transmit data, such as a public switched telephone network PSTN or a private local area network LAN. Establishment of a wireless or wired feedback connection to the server SR by means of network solutions known per se is obvious to a person skilled in the art, for which reason it is unnecessary to describe them in greater detail here. The server SR may comprise the subscriber services available or it can function as a router which forms service orders and establishes a connection to the desired service provider.

FIG. 1 illustrates, by way of example, a connection from the server SR to two service providers SP1 and SP2. Service provider SP1 is a public Internet service provider with which the server SR communicates via the public Internet network. Via the server terminal MT2 may order typical Internet files, e.g. HTML files or sound, picture or video files available on the Internet, from service provider SP1 for transmission via the server SR to local transmitter LT1, which forwards the ordered files to the terminal. Service provider SP2 is a private service provider who transmits sound or video files against payment and who can be contacted through a public or a private data network. Service provider SP2 sends e.g. recordings or video movies on the basis of the orders made by the terminals via the server SR for transmission from local transmitter LT1. The number of services which are liable to charge and function according to the ‘on demand’ principle can be increased as the data transmission capacity of the telecommunications systems according to the invention increases. It is clear that the number of service providers available to the server SR may differ from two which was used as an example; likewise the format of the services transmitted by the service providers may differ from the file and service formats described above. Since the telecommunications system of the invention is primarily designed for transmission of broadcast services, in the time slot of the multiplex frame assigned to local services it is advantageous to transmit order files and services which as many terminals as possible have ordered in the coverage area of the local transmitter. This holds true particularly when the share of the local output reserved for terminal-specific subscriber services is small.

As illustrated in FIG. 1, the server SR is preferably connected to local transmitters LT1 and LT3. According to the invention, the local transmitters generate local outputs and transmit them themselves in the time slots of the multiplex frame assigned to them. In that case it is advantageous to connect the server supplying subscriber services directly to local transmitters because each local transmitter can determine the capacity required by the broadcast services included in the local output, and thus excess capacity can be used for transmitting subscriber services provided by the server.

According to a preferred embodiment of the invention, selection data of the service to be ordered are formed in the server SR on the basis of the identification and control data included in the multiplex frames of the service files received from the service providers. This embodiment of the invention is based on the idea that the service files are transmitted to the server SR in a multiplex frame which also comprises identification and control data of the services the frame includes and possibly terminal configurations. The identification and control data of the frames are used for displaying selection data of the services that can be ordered to the user. These are preferably collected into a file of available services which is stored in the server SR supplying services and/or offered as a broadcast-type data service so that the information of services available is automatically transferred to a terminal connecting to the network. When the customer selects the desired service from the service list by means of his terminal, this selection information is transmitted to the server supplying subscriber services either along a wired or a wireless connection. After this, the selected service is sent, according to possible equipment specifications, from the local transmitter to the terminal in the frames defined in the identification and control data. Regardless of the path or the service provider's location, the user can browse the service list e.g. in the form of a name list from his terminal or on the screen connected to it without needing to know in which form, from where, which way and by what kind of device the service can be supplied. Service selection can also be implemented so that only selection data of the programme are available for selection in a device other than the terminal receiving the service. In that case selection can be made and the selection data forwarded by means of this other device, which is e.g. a computer, provided that identification data of the terminal which is to receive the ordered service are also supplied with the selection data. This ensures that the service is transmitted to the correct terminal regardless of the device used for selecting the service.

The embodiment of the invention described above is based on the idea that information on the available subscriber services is collected to the server SR, preferably into a separate file of available services, utilizing the control and identification data of the multiplex frames used for transmitting services. Information on the available order services is transmitted from the server SR to the terminals through a local transmitter without the actual service files. A file of available services can be transmitted automatically to the terminal when the terminal connects to the network or in response to a request for the file of available services. Preferably the file of available services can also be transmitted directly from the server SR if there is a bi-directional connection between the server SR and the terminal.

According to another preferred embodiment of the invention, the control and identification data of the local output can be preferably utilized for reserving transmission capacity for order services from the local output. According to FIG. 2, one or more time slots are reserved for the local output from the multiplex frame of the areal output, and the local transmitters may broadcast their own transmissions during these time slots. Each local output is provided with a multiplexed frame format according to FIG. 3. At the beginning of the frame 2 there are fields (2a) reserved for displaying the control and identification data (CD, ID) of the local services included in the frame 2. These control and identification data are used e.g. for determining what services are included in the frame and into which time slot each service is inserted. The control and identification data also include information on the transmission code which is used in each local area and on the basis of which the terminal can configure with a local service. The other time slots (2b, 2c, . . . ) of the frame 2 contain local broadcast services (BS1, BS2, . . .). Time slots, e.g. 2d and 2f in FIG. 3, can be reserved from the multiplex frame 2 of the local output for order services (OS1, OS2, . . . ). Also, in a situation in which local broadcast services do not use each time slot of the frame, the excess time slots can be assigned to transmission of order services. However, at the beginning of the multiplex frame 2 of the local output there is always a field 2a which comprises control and identification data and from which the terminal user receives information on the capacity reserved for order services. On the basis of this information the terminal user may make a request for reserving capacity to the local transmitter, preferably in connection with a service order made to the server SR. In that case the server SR can forward the request for capacity to the local transmitter, and having received an acknowledgement from the local transmitter the server SR initiates a procedure for forwarding the ordered service to the local transmitter for insertion into the frame of the local output. The server SR can also function as the element that is directly responsible for capacity reservations, and having received information on the total capacity and time slots reserved for order services from the local output the server SR can allocate the capacity according to the order requests made by the terminals, e.g. on the basis of certain priority rules. Since the local transmitters have been primarily designed for transmitting broadcast services, it is practical to prioritize services which a majority of terminal users want to order when allocating capacity.

To supply order services to the correct terminals and to prevent unauthorized reception of order services the terminals and transmitters must be identified somehow. According to a preferred embodiment of the invention, address practice in accordance with an Internet protocol (IP) can be used for this purpose. In that case the identification data of the multiplex frame of the local output include the IP address of said local transmitter, for example. This is a very useful method in the network arrangement according to the invention where subscriber services are ordered and transmitted chiefly in Internet-based networks. According to a preferred embodiment of the invention, a local area network address in accordance with the IP address practice can be determined for each local transmitter, and thus the coverage area of each local transmitter forms a kind of wireless local area network. Depending on the protocol version, the IP address comprises at least four bytes and each byte eight bits, of which e.g. two or three first bytes can be used for forming the local area network address. The remaining bytes can then be used for determining terminals that are registered with their home network within the coverage area of the local transmitter. The servers connected to the system are also preferably identified according to the IP practice.

According to a preferred embodiment of the invention, the procedure according to the Mobile IP protocol, which is known per se, can be used as the address practice of the terminals. According to the Mobile IP practice, two IP addresses are defined for identifying a terminal, i.e. a home address and a care-of-address. The home address is defined on the basis of the terminal's home network, in which case the terminal is identified when it is in the area of its home network and the data to be sent to it are routed according to the home address. When the terminal moves to another network, e.g. to the coverage area of another local transmitter, the care-of-address will be used for identifying the terminal. A new care-of-address is defined each time the terminal moves to the area of a new network. In this case it is possible to use e.g. a known DHCP (Dynamic Host Configuration Protocol) practice for dynamic definition of the address. The home network comprises a server (home agent) which maintains information on the care-of-address related to each home address. Thus the server can route files sent according to the home address of the terminal to the care-of-address, which is performed via the server of the foreign network (foreign agent).

The terminal itself recognizes only its own home address and the care-of-address is only used for routing transmission to the correct network, e.g. to the correct local transmitter. Therefore the destination address of a file transmitted from a wireless transmitter has to be changed so that the terminal can identify a file intended for it. The address is changed by the home agent, which adds the terminal's care-of-address to the file to be transmitted without editing the file and the original address in any way. Thus the foreign agent can forward the file to the terminal on the basis of this address information. The Mobile IP practice is known per se and described in greater detail e.g. in Internet RFC 2002. As regards implementation of the invention, it is thus unnecessary to describe the Mobile IP more closely.

The specification and the drawings describe the invention only by means of examples, and thus the invention is by no means limited to these examples. It is clear to a person skilled in the art that the invention can also be applied in any other network functioning in a similar way, e.g. in the network according to the DVB system. Thus the embodiments of the invention may vary within the scope of the appended claims.

I claim:

1. A wireless digital telecommunications system which comprises a main transmitter and a terminal, the main transmitter being arranged to transfer broadcast services to the terminal in a multiplexed frame format at one frequency and an auxiliary transmitter whose coverage area is substantially smaller than the coverage area of the main transmitter and which is synchronized with the main transmitter and arranged to send broadcast services to the terminal in a predetermined time slot of the main transmitter's multiplex frame.

2. A telecommunications system according to claim 1, wherein the time slot intended for the auxiliary transmitter is determined in a control and identification data field of the multiplexed frame sent by the main transmitter, the auxiliary transmitter being arranged to receive the frame.

3. A telecommunications system according to claim 1 wherein the main transmitter and the auxiliary transmitter are synchronized using a separate reference signal.

4. A telecommunications system according to any one of claims 1 to 3, wherein the auxiliary transmitter is arranged to send a code with broadcast services, the code being determined on the basis of the location of the auxiliary transmitter's coverage area, and the terminal being arranged to configure with services of the auxiliary transmitter on the basis of the code.

5. A telecommunications system according to claim 4, wherein the terminal is arranged to determine its location data on the basis of which the terminal is arranged to determine the code of the auxiliary transmitter used in the location area of the terminal.

6. A telecommunications system according to claim 5, wherein the terminal is arranged to determine its location data by means of a satellite location system.

7. A telecommunications system according to claim 1 wherein the auxiliary transmitter is arranged to send terminal-specific subscriber services to at least one terminal in a time slot of the main transmitter's multiplex frame predetermined for the auxiliary transmitter.

8. A telecommunications system according to claim 7, wherein the system further comprises at least one server transmitting terminal-specific subscriber services, there being a data transmission connection from the server to at least one auxiliary transmitter, and at least one terminal which is arranged to establish a data transmission connection to at least one server transmitting terminal-specific subscriber services, the data transmission connection being used for transmitting orders of said subscriber services to said server.

9. A telecommunications system according to claim 8 wherein the server transmitting terminal-specific subscriber services is arranged to establish a connection to at least one subscriber service server the services of which the server transmitting subscriber services is arranged to transfer to the auxiliary transmitter for transmission to the terminal that has made the order.

10. A telecommunications system according to claim 9, wherein the server transmitting terminal-specific subscriber services is arranged to form selection data of the subscriber services on the basis of control and identification data in the multiplex frames which it has received and which are used for transmitting subscriber service files, and the selection data are supplied to at least one terminal without subscriber service files.

11. A telecommunications system according to any one of claims 8 to 10 wherein the terminal is arranged to receive information on the capacity reserved for terminal-specific subscriber services from a local output in the control and identification data fields of the multiplex frame of the local output, and the terminal is arranged to establish a data transmission connection to at least one server transmitting terminal-specific subscriber services, the data transmission connection being used for reserving capacity from the local output for a subscriber service to be transmitted to the terminal.

12. A telecommunications system according to claim 1 wherein the identification data of the auxiliary transmitters and terminals are formed according to the address practice of an Internet protocol (IP).

13. A telecommunications system according to claim 12 wherein the identification data of mobile terminals are formed according to the address practice of a Mobile IP protocol.

14. A transmitter for sending broadcast services in a multiplexed frame format at one frequency wherein the transmitter is arranged to synchronize with a main transmitter whose coverage area is substantially larger than the coverage area of the transmitter, and wherein the transmitter is arranged to transmit broadcast services in a predetermined time slot of the main transmitter's multiplex frame.

15. A transmitter according to claim 14, wherein the transmitter is arranged to receive the multiplex frame sent by the main transmitter, and the transmitter is arranged to determine at least one time slot intended for said transmitter on the basis of a control and identification data field in the multiplex frame of the main transmitter.

16. A transmitter according to claims 14 or 15 wherein the transmitter is arranged to synchronize with the main transmitter by means of a separate reference signal.

17. A transmitter according to claim 14 wherein the transmitter is arranged to send a code with broadcast services which is determined on the basis of the location of the coverage area of said transmitter.

18. A transmitter according to claim 14 wherein the transmitter is arranged to send terminal-specific subscriber services to at least one terminal in the time slot intended for the transmitter.

19. A transmitter according to claim 18 wherein a data transmission connection is established from the transmitter to at least one server transmitting terminal-specific subscriber services, the server being arranged to establish a connection to at least one subscriber service server the services of which said server transmitting subscriber services is being arranged to transmit to said transmitter for transmission to the terminal that has made the order.

20. A transmitter according to claim 14 wherein the identification data of the transmitter are formed according to the address practice of an Internet protocol (IP).

21. A terminal for receiving broadcast services transmitted in a multiplexed format at one frequency, the terminal being arranged to receive a multiplex frame sent by a main transmitter and to configure with the desired service on the basis of the information in the control and identification data field of said frame wherein the terminal is arranged to configure with a local service sent by another transmitter on the basis of the information in the control and identification data field of said frame.

22. A terminal according to claim 21 wherein the terminal is arranged to determine its location data and the code used by said other transmitter on the basis of these location data.

23. A terminal according to claim 22 wherein the terminal is arranged to determine its location data by means of a satellite location system.

24. A terminal according to any one of claims 21 to 23, wherein the terminal is arranged to establish a data transmission connection to at least one server transmitting terminal-specific subscriber services, said data transmission connection being used for transmitting the orders of the subscriber services to the server, the terminal being arranged to receive the subscriber services in a local output.

25. A terminal according to claim 24 wherein the terminal is arranged to receive selection data of subscriber service files without the subscriber service files, the selection data of the subscriber service files being formed on the basis of control and identification data of the multiplex frames used for transmitting subscriber service files.

26. A terminal according to claim 24 wherein the terminal is arranged to receive information on the capacity reserved for terminal-specific subscriber services from the local output included in the control and identification data field in the multiplex frame of the local output, and the [said] terminal is arranged to establish a data transmission connection to at least one server transmitting terminal-specific subscriber services, the data transmission connection being used for reserving capacity for the subscriber service to be transmitted to said terminal from the local output.

27. A terminal according to claim 21 wherein the identification data of the terminal are formed according to the address practice of an Internet protocol (IP) or a Mobile IP protocol.
